(19) United States
(12) Patent Application Publication
(10) Pub. No.: US 2013/0264285 A1
(43) Pub. Date: Oct. 10, 2013

(54) PROCESS AND FACILITY TO TREAT CONTAMINATED PROCESS WATER

(71) Applicants: Peter Douglas Macintosh, Peppermint Grove (AU); Luke Andrew Reeves, Scarborough (AU); Mark Alistair Peacock, Gwelup (AU); Neil Wende, Coolbinia (AU); Paul Robert Kucera, Valrico, FL (US); Colin George Weyrauch, Brandon, FL (US)

(72) Inventors: Peter Douglas Macintosh, Peppermint Grove (AU); Luke Andrew Reeves, Scarborough (AU); Mark Alistair Peacock, Gwelup (AU); Neil Wende, Coolbinia (AU); Paul Robert Kucera, Valrico, FL (US); Colin George Weyrauch, Brandon, FL (US)

(73) Assignee: HATCH LTD., Mississauga, ON (CA)

(21) Appl. No.: 13/816,860

(22) PCT Filed: Aug. 13, 2010
(86) PCT No.: PCT/CA2010/001265

§ 371 Date: Jun. 21, 2013

(51) Int. Cl. C02F 9/00

(52) U.S. Cl. CPC C02F 9/00
USPC 210/636; 210/652; 210/651; 210/259; 210/195.2; 210/202

(57) ABSTRACT

Process and facility for treating an aqueous solution containing substantial concentrations of a variety of contaminants, including solids, semi-solids, colloids, complexes, oligomers, polyvalents, organics and monovalents, and which tend to form gels and scale precipitates when their concentration levels are increased during treatment of the aqueous solution, the process comprising the steps of: a) feeding the aqueous solution to an ultrafiltration (UF) plant and recovering therefrom an UF permeate reduced in such suspended solids, semi-solids and colloids; b) feeding the UF permeate obtained from step (a) to a nanofiltration (NF) plant and recovering therefrom an NF permeate reduced in such complexes, oligomers, polyvalents and organics; and feeding the NF permeate obtained from step (b) to a first reverse osmosis (RO) plant and recovering therefrom an RO permeate reduced in such monovalents. The process and facility may be used for treating process water from wet process phosphate acid production.

### FIELD

The present subject matter relates to the treatment of industrial and mining process waters contaminated in high concentrations of scaling ions and gel forming precipitants such as silicates and phosphates. The process and facility disclosed can be applied, for example, in the treatment of phosphate mining process waters.

### BACKGROUND

Certain aqueous solutions contaminated in high concentrations of scaling ions and gel forming precipitants, such as phosphate mining process waters, have proven notoriously difficult to treat, without producing significant quantities of waste solids and/or excessive consumption of filter elements.

The process water for wet process phosphoric acid production is produced from evaporator condensate used to concentrate the phosphoric acid from a nominal 30% to higher concentrations. The condensate typically contains volatile components of fluoride, silica, and carry over of residual phosphate, and other components including organic compounds. The process water, which has a pH between 1.0 and 4.0, is used through the process plant and also contains material from gypsum washing and the production of ammonium salts of phosphate.

The process water thus contains a significant loading of compounds containing silica, fluorosilicates, gypsum, fluoride, various metals and ammonium compounds in solution, many of which are supersaturated. Precipitation of certain species (such as silicates and organics) forms gel compounds, either during the precipitation process or later. The process water also contains materials that are still reacting, or polymerizing, from dissolved species to semi-solids (typically in the hydrated form which behave like gel materials), and ultimately to solids. A wide range of molecular weights is also present in the process water as a result of the original constituents of the solution or due to subsequent reaction processes.

Reverse osmosis has been considered as a candidate for treating process waters from mining and industrial processes; however, considerable problems arise with harsh, complex aqueous solutions such as those described above. The practical application of nonporous semipermeable membranes used in reverse osmosis can be severely limited by the fouling of the membrane surface. Solutes in the feed stream may be supersaturated or become supersaturated (due to the removal of permeate) causing a process of precipitation leading to a build up of scale. Typically this is a mineral precipitate, but it may also be organic. Fouling is also caused by the deposition of solids and colloids (suspended in solution) on the surface of the membrane. Both deposition fouling and scaling mechanisms and their interaction with the membrane surface are complex.

The traditional approach for reverse osmosis treatment of waters containing high levels of contaminants that might cause fouling, including saturated solutions, is to pre-treat the solution by precipitation and clarification or flocculation and filtration using media filters or similar, prior to a membrane process. Specific problems are associated with process or pond water from phosphate fertilizer manufacture, which contains an array of semi-polymerized solids, colloids and organic matter, in addition to dissolved solids.

One technique that has been used is to treat these waters with a double liming process preceding reverse osmosis treatment. The double liming process uses two steps of lime addition and precipitation. This process results in significant quantities of sludge generation and the discharge water or supernate requires further post treatment of ammonia removal. Furthermore, with this technique, the recovery of ionic values for re-use is compromised and the cost of the lime can also be a significant expense.

Another technique that has been attempted involves passing the supernate liquor through a filtration stage involving sand filters, a filtrate stage involving cartridge filters, followed by two passes of reverse osmosis. There are significant issues with this arrangement resulting in below design flows and high consumption of filtration and membrane elements. There are also significant scaling issues in the reverse osmosis stages with the concentrated species.

### SUMMARY

This summary is intended to introduce the reader to the more detailed description that follows and not to define or limit any claimed subject matter.

In accordance with a first aspect, a process is provided for the treatment of an aqueous solution containing substantial concentrations of a variety of contaminants which may include solids, semi-solids, colloids, complexes, oligomers, polyvalents, organics and monovalents, and which tend to form gels and scale precipitates when their concentration levels are increased during treatment of the aqueous solution, the process comprising the steps of:

a) feeding the aqueous solution to an ultrafiltration (UF) plant and recovering therefrom an UF permeate reduced in such suspended solids, semi-solids and colloids;

b) feeding the UF permeate obtained from step (a) to a nanofiltration (NF) plant and recovering therefrom an NF permeate reduced in such complexes, oligomers, polyvalents and organics; and

c) feeding the NF permeate obtained from step (b) to a first reverse osmosis (RO) plant and recovering therefrom an RO permeate reduced in such monovalents.

The aqueous solution may in some embodiments contain at least some species from the group consisting of phosphates, silica compounds, fluorosilicates, sulfates, fluoride, metals, ammonium compounds, and organics. In some cases, at least some of said species are present in the aqueous solution at or near their saturation levels.

The aqueous solution may be, in certain examples, process water from wet process phosphoric acid production. In some such cases, the process also includes the steps of recovering a phosphate bearing retentate from the nanofiltration plant and recycling a portion of such phosphate bearing retentate to phosphate production.

In certain embodiments, the RO permeate obtained from step (c) contains fluoride, and the process also includes the step of feeding the RO permeate obtained from step (c) to a second reverse osmosis (RO) plant and recovering therefrom a second RO permeate substantially reduced in fluoride. Sodium hydroxide may be added to the RO permeate obtained from step (c) raising its pH to at least 8.0 prior to feeding it to the second reverse osmosis (RO) plant. Such a process may also include the steps of recovering a retentate from the first reverse osmosis plant and feeding a portion of such retentate to the nanofiltration plant by adding it to the UF permeate obtained from step (a).

In some examples, the process further comprises the steps of recovering a sodium fluoride bearing retentate from the first or second reverse osmosis plant, adding sulfuric acid to at least a portion of such sodium fluoride bearing retentate, and using the resulting solution to clean mineral deposits in at least one of the ultrafiltration, nanofiltration, or reverse osmosis plants.

In some embodiments, the UF permeate obtained from step (a) contains fewer than 15% of the suspended solids, semi-solids and colloids present in the aqueous solution (in some cases fewer than 5%), and the NF permeate obtained from step (b) contains fewer than 30% of the complexes, oligomers, polyvalents and organics present in the aqueous solution (in some cases fewer than 20%).

In accordance with a second aspect, a facility is provided for the treatment of an aqueous solution containing substantial concentrations of a variety of contaminants which may include solids, semi-solids, colloids, complexes, oligomers, polyvalents, organics and monovalents, and which tend to form gels and scale precipitates when their concentration levels are increased during treatment of the aqueous solution, said facility comprising: an ultrafiltration (UF) plant that is operable to receive the aqueous solution and produce an UF permeate reduced in such suspended solids, semi-solids and colloids; a nanofiltration (NF) plant that is downstream of the ultrafiltration plant and that is operable to receive the UF permeate and produce an NF permeate reduced in such complexes, oligomers, polyvalents and organics; and a first reverse osmosis (RO) plant that is downstream of the nanofiltration plant and that is operable to receive the NF permeate and produce an RO permeate reduced in such monovalents.

In certain embodiments, the treatment facility is integral to a wet process phosphoric acid production plant and the aqueous solution is process water from the phosphoric acid production plant. In some cases, a portion of the retentate from the nanofiltration plant is recycled to the phosphoric acid production plant.

In certain embodiments, the treatment facility further comprises a second reverse osmosis (RO) plant that is downstream of the first reverse osmosis plant and that is operable to receive the RO permeate from the first reverse osmosis plant and produce a second RO permeate reduced in fluoride. In some such cases, the facility includes an alkalizing stage for raising the pH of the RO permeate from the first reverse osmosis plant to at least 8.0 prior to its being received by the second reverse osmosis plant. Moreover, a portion of the retentate from the first reverse osmosis plant may be fed to the nanofiltration plant.

In certain embodiments, the treatment facility further comprises an acidifying station for adding sulfuric acid to retentate from one of the reverse osmosis plants to produce a solution for cleaning mineral deposits in at least one of the ultrafiltration, nanofiltration, or reverse osmosis plants.

### DRAWINGS

Embodiments will be described in the following section with reference to the accompanying drawings in which:

FIG. 1 is a simplified overall schematic of a treatment facility using a process according to a first embodiment;

FIG. 2 is a simplified overall schematic of a treatment facility using a process according to a second embodiment;

FIG. 3 is a schematic showing the UF plant and the NF plant used in both embodiments;

FIG. 4 is a schematic showing the RO plant used in the second embodiment;

FIG. 5 is a schematic showing details of the UF plant used in both embodiments; and

FIG. 6 is an isometric view of a UF membrane module used in the UF plant in both embodiments.

### DESCRIPTION OF VARIOUS EMBODIMENTS

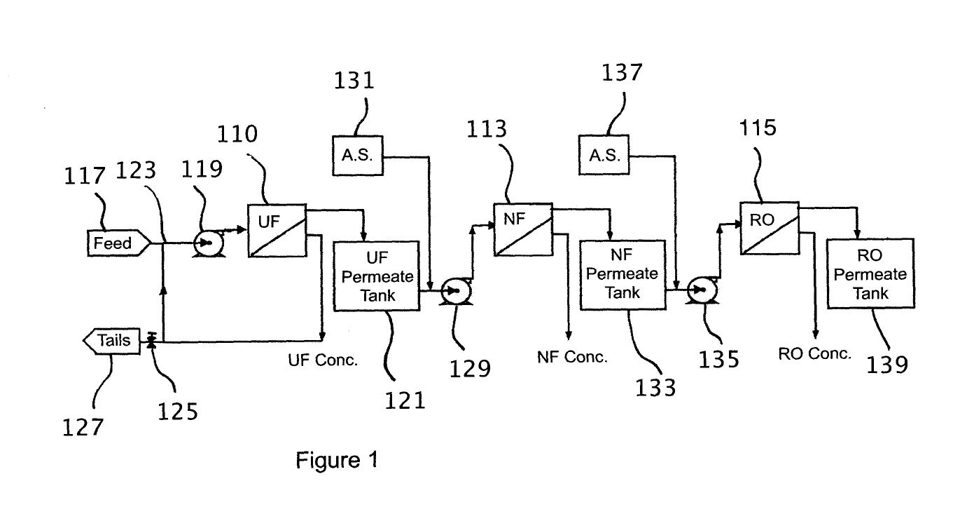

Referring to FIG. 1, a graduated membrane water treatment facility used in a first embodiment is illustrated. This comprises a train (in series) of an ultrafiltration plant 110, a nanofiltration plant 113, and a reverse osmosis plant 115. Feed 117 from the process water pond is supplied under pressure and at elevated temperature and passes through a screen in the form of a mechanical screen (not shown) to filter out any large solids of 1/16 inch or greater, and is pumped in recirculatory manner by an array of pumps 119. UF permeate passes to a UF permeate holding tank 121, while concentrated feed is recycled back to the feed stream 123, and a portion is bled off via a retentate bleed valve 125 and discharged 127 to the process water pond.

Liquor from the UF permeate holding tank 121 is pumped by an array of pumps 129, along with antiscalant which is metered from a reagent tank 131, to the nanofiltration plant 113. Permeate from the NF plant 113 is fed to an NF permeate holding tank 133, while NF concentrate is taken off for further processing which may include recovery of compounds therefrom.

Liquor from the NF permeate holding tank 133 is pumped by an array of pumps 135, along with antiscalant which is metered from a reagent tank 137, to the reverse osmosis plant 115. Permeate from the reverse osmosis plant 115 is fed to an RO permeate holding tank 139, while RO concentrate is taken off for further processing which may include recovery of compounds therefrom, or recycle to the UF permeate holding tank 121.

This facility is suited to treatment of phosphate mining tails which are either substantially neutral or do not have fluoride ions present.

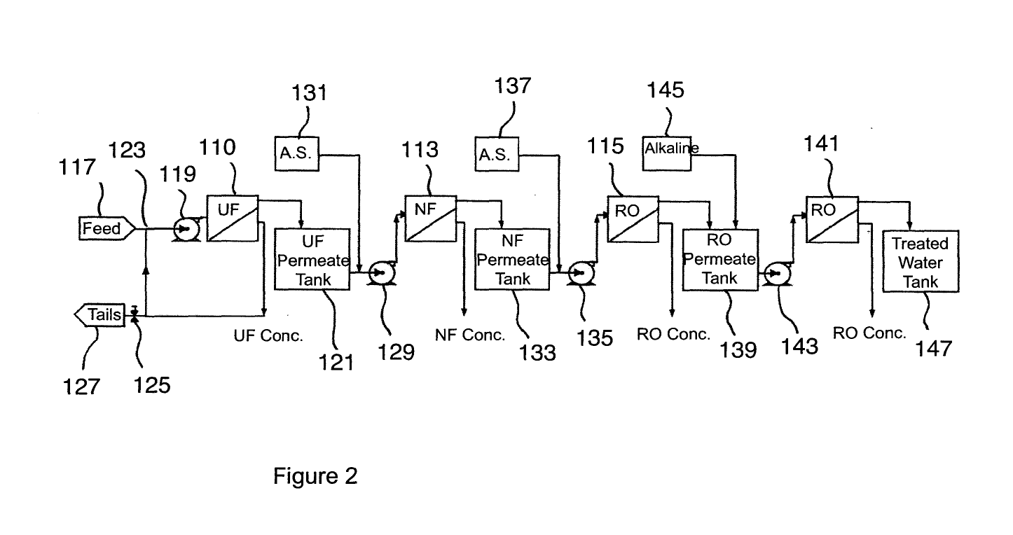

The graduated membrane water treatment facility utilized in the second embodiment illustrated in FIG. 2 is similar to the first embodiment and is intended to deal with feed 117 which is acidic and contains halides, particularly fluoride, which will be present as hydrofluoric acid (HF) in the RO permeate holding tank 139. The second embodiment includes a second reverse osmosis plant 141. Liquor from the RO permeate holding tank 139 is pumped by an array of pumps 143, along with pH adjustment by sodium hydroxide additive which is metered from a reagent tank 145, to the reverse osmosis plant 141. Permeate from the reverse osmosis plant 141 is fed to a treated water holding tank 147, while RO concentrate is taken off for further processing which may include recovery of compounds, such as sodium fluoride therefrom.

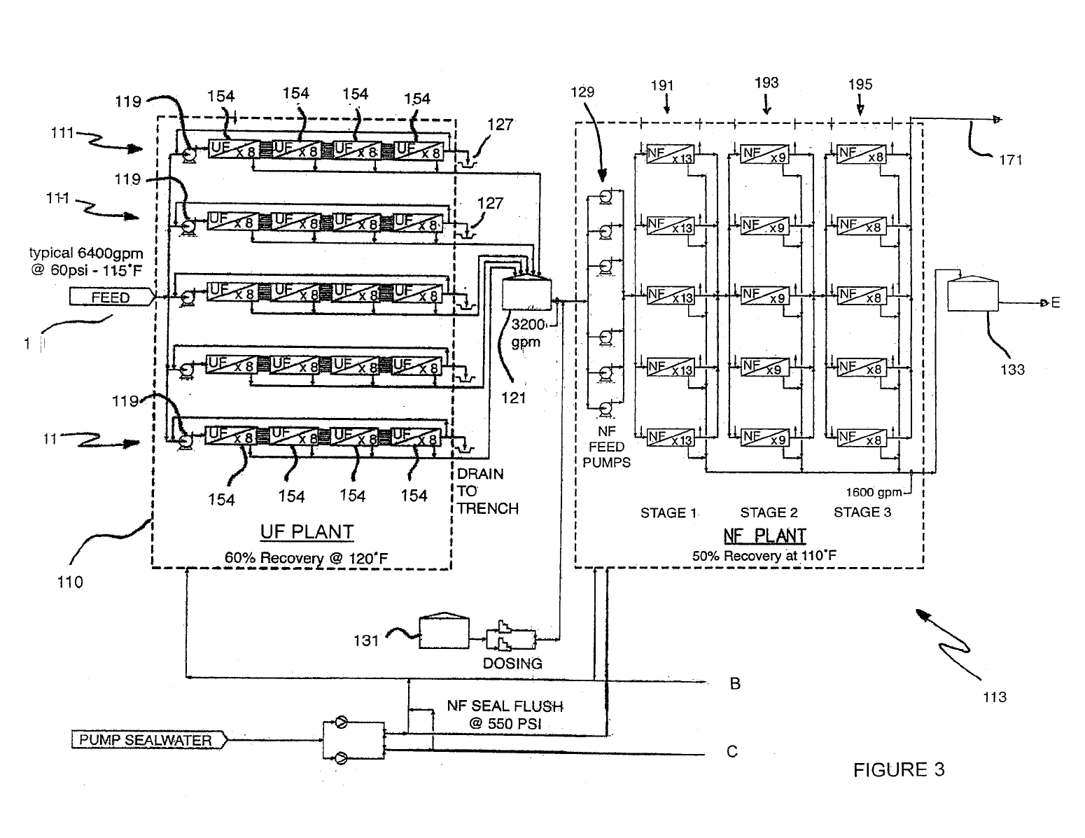

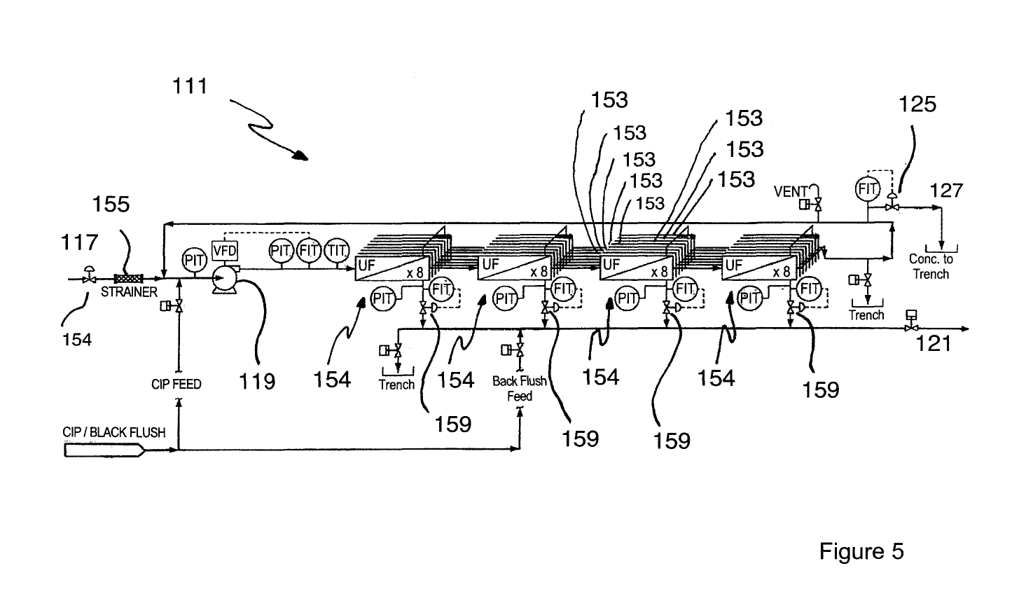

Referring to FIG. 3, further detail of the UF plant 110 and NF plant 113 is shown. The UF plant 110 comprises five like ultrafiltration membrane units 111 operating in parallel. Each ultrafiltration membrane unit 111 has eight parallel trains of four ultrafiltration membrane modules 153, arranged for series pass of feed/concentrate. The eight parallel trains are grouped into four stages 154, as four mechanical assemblies, but there is no cross-train mixing of feed concentrate between successive stages 154. Feed concentrate from the fourth ultrafiltration membrane module 153 of each of the eight parallel trains is recombined before being recirculated to the pump 119 in each ultrafiltration membrane unit 111. Each ultrafiltration membrane unit 111 has its own recirculatory pump 119 associated therewith. In FIG. 5, an ultrafiltration membrane unit 111 is illustrated in greater detail. Each ultrafiltration membrane unit 151 comprises the eight parallel trains of four ultrafiltration membrane modules 153, which are in the form of cylindrical canisters, and for simplicity are shown as leafs in FIG. 5. Each of the eight parallel trains of four ultrafiltration membrane modules 153 are connected to pass feed/concentrate in series.

It will be understood that the number of trains of four ultrafiltration membrane modules 153 in parallel, the number of parallel trains of ultrafiltration membrane units 111 and the number of modules 153 in series in each train are determined based on the nature of the feed 117, and downstream processing capacity.

Further detail of the graduated membrane water treatment facility will be described in its application to the treatment of phosphate mining tails which are acidic and high in fluoride, phosphorus, nitrogen, sulfur (primarily as sulfate), silicon and calcium.

Heated feed water at nominally 110° F. from the pond or water body is supplied to the feed 117 and sent to the UF plant 110 for filtration. The feed 117 system is designed to provide a continuous supply of heated feed water to the UF plant 110 on a 24 hour a day 7 day week basis. The feed water is measured for flow, pressure, temperature and conductivity. The temperature should be nominally 110° F. (80 F to 120° F.) and the conductivity may range from 15,000 μS/cm to 40,000 μS/cm (typically˜29,000 μS/cm). Outside these ranges, plant performance is compromised by poor permeate quality or membrane plant damage. The materials of construction consist of suitable polymeric materials and Stainless Steel 316 or better.

A typical analysis of the feed water is 35,700 ppm total dissolved solids, including 7,350 ppm dissolved phosphorus present in anionic form, 700 ppm dissolved nitrogen present primarily as NH₄⁺ and NO₃⁻, 9,200 ppm fluorine present as F⁻ and SiF₆²⁻, 1,200 ppm dissolved calcium, 200 ppm dissolved magnesium, 150 ppm dissolved iron, 1,750 ppm dissolved silicon present as SiF₆²⁻ and SiO₃²⁻, 2,250 ppm dissolved sodium, 8,200 ppm dissolved sulfate and 330 ppm dissolved potassium.

The feed water is treated by a process of ultrafiltration (UF plant 110), nano-filtration (NF plant 113), reverse osmosis (reverse osmosis plant 115), pH adjustment, then a final reverse osmosis operation (reverse osmosis plant 141) with the necessary facility services and cleaning devices to maintain the facility in operation. In each unit of operation the filtrate or permeate proceeds to the next unit of operation via a break tank or unit operation product tank (121, 133, 139). The concentrate or retentate is discharged from each unit operation and returned to the water body or it may be reused or recycled within the facility or other facilities to recover resources or be utilized as a water source for other applications. Due to the high level of dissolved solids and high propensity for scale, all process lines have the ability to be flushed with cleaning water and any dead legs in the lines should be avoided. All process lines and equipment should be thoroughly cleaned and flushed at regular intervals and prior to any shutdown. Details of arrangements for cleaning are described in the applicant's concurrently filed patent application entitled “Membrane Treatment/Filtration Plant and Control System”, the contents of which are incorporated herein by cross-reference.

The UF plant 110 removes virtually all suspended solids including semipolymerized solids, large colloids and organic molecules from the feed stream. The UF system relies on a system of semi-permeable membranes to separate a solution that contains a combination of suspended solids and dissolved solids.

Each ultrafiltration membrane unit 111 has a feed strainer 155, a recycle pump 119, and eight parallel trains of UF membrane modules 153 arranged in four stages in series. The number of parallel trains of modules 153 is determined based on the pumping capacity of the recirculation pump 119. Pressure is measured in the feed 117 pipeline prior to the ultrafiltration membrane unit 111 then after the strainer 155, and on the recirculation pump 119 suction and discharge. Pressure is also measured on each permeate line from each UF stage. Flow is measured on the recirculation pump 119 discharge, on the permeate lines from each UF stage and on the retentate (feed concentrate). Temperature is measured at the feed to the ultrafiltration membrane unit 111 and also on the recirculation pump 119 discharge. Data gathered from this instrumentation can be used to control the UF plant 110 and to schedule periodic flushing and cleaning operations, necessary to maintain the UF plant 110 in operation.

An actuated feed valve 157 is used to isolate the feed 117 solution from entering the ultrafiltration membrane unit 111 and the recirculation pump 119 and strainer 155 can be isolated using manual valves. The recirculation pump 119 operates to a design flowrate that may be manipulated depending on operating conditions but is usually operated at 8.2 to 13.5 ft/sec membrane cross flow. The pump has an automated shutdown at a maximum pressure that relates to the maximum working pressure of the membrane and modules, which is 120 psi.

Thirty two (32) UF modules 153 are provided for the entire UF plant 110 with each module 153 having an area of 355 sqft (33 m²). The feed to each ultrafiltration membrane unit 111 is supplied at a nominal flow of 1280 gpm at 20-40 psi at the suction of the recirculation pump 119. The feed 117 fluid is screened to remove bulk solids and passed through the strainer 155 which is less than one third of the diameter of the tubular UF membranes to remove scale and other large foreign objects prior to fluid entering the ultrafiltration membrane unit 111. The UF plant 110 is operated at a desired recovery where 50% (or 0-100%) of the feed is filtered then reports to the UF permeate tank 121. The feed water which is concentrated due to removal of the UF permeate, is delivered to the recirculating pump 119 where the pressure and flow are boosted to the desired cross flow velocity for the membrane.

The feed water passes through the UF membrane module 153 tubes from the inside-out, which means that the substances retained by the membrane are in a clearly defined space being the lumen or inside of the tube, where they are removed by either back-pulsing or chemical cleaning or a combination of both. A back-pulse will remove much material which begins to clog the pores in the tubular membrane material, and by the nature of the design of the membrane modules 153, this makes the modules 153 amenable to physical cleaning in this manner. However, over time more stubborn deposits which cannot be removed by physical back-pulsing may require chemical cleaning.

The feed water enters the ultrafiltration membrane unit 151 and hence modules 153 at stage one and progresses sequentially through to stage 4 where it repeats in a recycle fashion by aid of the recycle pump 119 to achieve the desired membrane crossflow. Fresh feed 117 is added continuously and a portion of the feed solution permeates through each tubular membrane in a controlled fashion at a desired flux rate which may be anywhere from 0 to 170 gfd (gallons per square ft per day), but is typically operated at 90 to 100 gfd. The desired flux rate or 96 gfd is achieved by manipulating the flux control valves 159 at the target permeate flow as measured by individual stage permeate flow meters. The remaining feed is bled from the system via the retentate bleed valve 125 at the desired plant recovery of 60%. Typical plant recovery is in the range of 40% to 70%, but higher recovery is possible at lower flux rates.

Flux control is used to maintain an even flow of permeate from each stage of the membrane facility. As each membrane module has a pressure loss associated with it, the following stage in a train having a lower feed pressure than the preceding stage. Thus on a nominal four stage plant with the feed pressure at 80 psi to the first stage, it will typically have only 30 psi exiting from the last stage. As the permeate pressure is discharging into an open tank, the unrestricted permeate back pressure is effectively 0 psi.

Thus the start of the 1st stage has a Trans Membrane Pressure (TMP) of ˜80 psi while the end of the 4th stage the TMP will be ˜30 psi or 2½ times less. In this example, the first stage membrane would produce some 2% times more permeate than the last stage and this brings with it an associated increase in scaling rates and may necessitate increased cleaning frequency.

By introducing permeate flux control, the permeate rate can be evenly maintained through the four stages and thus the scaling rate will be more consistent and the plant will have a decrease in the membrane cleaning requirement and have an increase in overall production due to longer cycle times.

Flux control is performed by installing a control valve and flow measuring instruments on the permeate line to monitor and maintain the permeate flow from each stage at the target flow rate. The permeate back-pressure is also measured to enable the membrane resistance to be calculated. While the membrane resistance value is not actually directly used in plant control, the values are closely monitored and used to alter UF targets to obtain an improvement in overall plant performance.

Manual valves allow the plant to be isolated for maintenance, and sample valves allow for the interrogation of system performance.

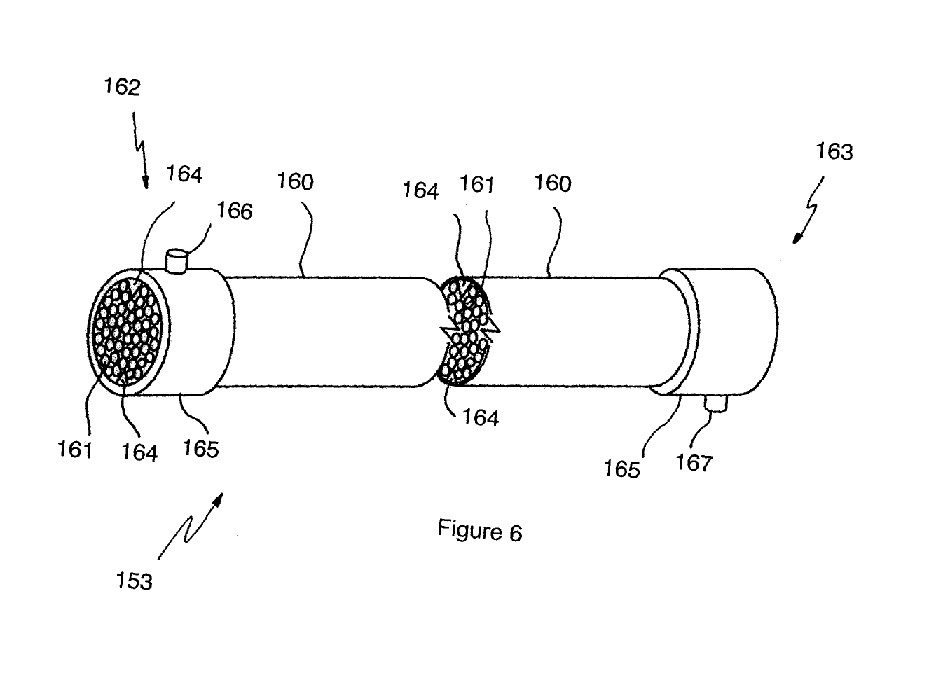

Referring to FIG. 6, a UF membrane module 153 is shown. The UF membrane module 153 comprises a housing 160 of 8 inch inside diameter and 3 metres in length (9.84 feet). This housing is filled with around 800×5.2 mm diameter tubes 161 which extend from one end 162 of the housing 160 to the other end 163. The tubes 161 completely fill the housing 160, apart from voids 164 forming an upper triangular segment and a lower triangular segment which extend along the length of the housing 160. External collars 165 fit over the ends 162 and 163 of the housing 160. The tubes 161 are sealed together by an epoxy resin at each end 162 and 163, so that the exteriors thereof communicate fluidly inside the housing 160 and also with an upper permeate port 166 and a lower permeate port 167 which extend through collars 165 proximal to the voids 164. In use, an inlet port and an outlet port (not shown) sealingly connect with each respective end 162 and 163 to supply feed/concentrate for passage through the lumen of the tubes 161. In use only the lower port 167 is used to collect UF permeate, while the upper port 166 is used to bleed off air. The tubes are constructed from poly vinylidene fluoride membrane (PVDF) cast on a polyester carrier. The tubes 161 have an average pore size of 0.030 μm. This ensures removal of all particulate matter larger than 0.03 μm, including colloids, solids including semipolymerized solids and micro-organisms, producing UF permeate filtrate with virtually no suspended solids. The housing is formed of UPVC in order to withstand low pH and high temperature. This provides an unexpected advantage over the use of normal PVC, allowing for 10% greater membrane area than in a standard PVC housing, and in turn reducing the number of modules 153 required by approximately 10%.

The UF plant operation is maintained via a multifaceted cleaning system which includes the combination of backflushing or back-pulsing and chemical cleaning, or clean in place (CIP) sequences. These sequences are timed and may also be operator initiated. Both methods of cleaning involve a sequence of valve openings and closures in a predetermined method to enable cleaning solutions to enter the plant.

The back-pulse dislodges solids that have accumulated on the membrane surface and enables them to be washed away when the plant is operating normally. Functionally, the back-pulse applies a short duration burst (1 to 2 minutes) of fluid to the membrane tube from the outside-in which is the reverse of the normal flow direction, thus dislodging solids that have accumulated on the inside of the tube. The back-pulse fluid used is normally reverse osmosis treated water that has been acidified with sulfuric acid to a pH less than 7 and the addition of fluoride. Importantly, during the back-pulse, the UF is off line for a short duration.

Backpulses are performed where solution is reverse flowed through the permeate lines and into the tubular UF and to waste. The backpulse flowrate is supplied by a backflush pump and the flowrate should be as high as possible, and preferably twice the flow as normal permeate flow, with the limit being on the backpressure applied to the permeate side of the membrane. The backflush pump has a maximum pressure shutdown that relates to the maximum backpressure allowed by the membrane and modules or −14.5 psi.

Whilst the back-pulse is very effective at limiting build-up of solids on the inside of the membrane tube, there is expected to be a small quantity of solids which remains attached after each back-pulse. Any such remaining solids that accumulate over time can be removed by periodic chemical cleaning.

Chemical cleaning of the UF requires the unit to be taken off line and isolated from the main process stream. Whilst off line, a cleaning chemical consisting of an acidic solution and an alkaline solution is circulated through the membrane effectively dissolving and dispersing any accumulated solids that were not removed during previous back-pulses. The cycle duration of the chemical clean is about an hour and it occurs about once every one to four days.

The NF plant 113 is designed to remove multivalent and complex ions to a NF concentrate stream 171 whilst allowing monovalent ions to pass through to the NF permeate holding tank 133. The NF membranes allow some Na and most of the K to pass through and present in the permeate thereby flowing to the next phase of treatment, whereas approximately half the Si and F, which are predominantly present as complex species, are held back on the concentrate side of the membrane and hence removed from the fluid to the NF concentrate stream 171, which can be treated by subsequent processes.

The selective separation concentrates the potassium fluorosilicate and sodium fluorosilicate complexes, thus reducing the load on the downstream RO process from fluorosilicate scale formation. NF plant 113 recovery is enhanced with higher temperature feed by heating the feed to from 110 F to 120 F, to minimize fluorosilicate scale formation.

The NF membrane construction is typical of that of a RO element with the following differences. The NF membranes elements have a minimum salt rejection of 97% rejection magnesium sulfate at a standard set of conditions, being 110 psi pressure, 2000 ppm MgSO₄ feed, operating at 15% recovery. The membrane is constructed of a polyimide material and is of 8″ diameter spiral construction, wound around a centrally located permeate tube.

The membrane element contains a number of polyamide membrane leaves that are wrapped in a spiral fashion around the centrally located noryl permeate tube and bound in place by an external wrap. Each membrane leaf consists of a polyamide membrane envelope that has a high pressure polypropylene permeate carrier enclosed allowing any permeate that passes through the membrane to be transported to the permeate tube. A high temperature polyurethane glue is used to bind and seal the seams of the membrane envelope. Placed between each membrane leaf is a polypropylene feed spacer that is a tricot woven diamond pattern and 0.028 inches thick. The feed spacer allows the feed solution to flow across the membrane sheet thus providing contact with the membrane surface permitting a portion of the feed to permeate through the membrane into the high pressure permeate carrier, from where it flows spiraling inwards to reach the permeate collection tube. These membrane leaves are wrapped around the permeate tube and capped at either end by a polysulfone anti telescoping device and wrapped by a fiberglass wrap with a double coating of an epoxy gel coat to maintain structural integrity.

The nanofiltration elements are 40 inches long and 8 inches in diameter. They are arranged serially in groups of six and housed in cylindrical nanofiltration membrane housings (not shown). O-rings of tetra fluoroethylene propylene copolymer such as those supplied by DuPont Performance Elastomers under the Viton™ ETP trade mark, are fitted around the external circumference of the anti-telescoping devices interfere with the interior of the cylindrical nanofiltration membrane housings and prevent feed/concentrate from bypassing the membrane leaves. Other o-rings to seal connectors connecting the permeate tubes can be made of ethylene propylene diene monomer.

The NF plant 113 equipment consists of a feed strainer (not shown), high pressure feed pumps 129 arranged in parallel, and NF membrane modules arranged in series in three stages 191, 193, and 195. The fluid flow for the NF plant is depicted in FIG. 3. The concentrate from the first stage is the feed for the second stage and the concentrate from the second stage is the feed for the third stage. Similar quality permeate is produced from each stage.

Each stage 191, 193, and 195 has a reducing number of NF membrane housings The first stage 191 has thirteen nanofiltration membrane housings arranged in parallel. The second stage 193 has nanofiltration membrane housings arranged in parallel, and the third stage 3 has nanofiltration membrane housings arranged in parallel. The number of nanofiltration membrane housings in each stage is dictated by the hydraulics of the system.

Pressure is measured in the feed pipeline to the NF plant 113 on the feed pump suction and discharge. Pressure is also measured on the feed to subsequent stages and on the permeate of each stage and train where multiple trains are employed. Pressure is also measured finally prior to concentrate pressure control valves where the retentate is discharged. Due to the high scaling potential, multiple concentrate pressure control valves are employed in a duty/standby fashion.

Flow is measured at the feed to each membrane stage and also on the permeate of each stage, and on each train where multiple trains are employed. Feed temperature is measured in the UF permeate tank. The NF plant performance is monitored using conductivity meter on the common NF permeate line to the permeate tank.

The NF feed tank is isolated from the NF plant via an actuated feed isolation valve. The high pressure pump and strainer can be isolated by manual valves. Feed from the NF feed tank is transferred to the NF plant via high pressure feed pumps capable of delivering the desired flow rate at up to the maximum pressure rating of the membrane and membrane housings. The feed pump(s) is/are protected by a pump strainer and a high pressure alarm and a temperature switch which shutdown the pump upon activation.

The high pressure pump operates to a target flowrate that may be manipulated depending on operating conditions but is usually operated at 70 gpm (20 to 80 gpm) per membrane vessel in the first stage. The pump has a maximum pressure shutdown that relates to the maximum working pressure of the NF membrane modules of 600 psi. The feed pressure is controlled via the concentrate pressure control valve at the pressure required to achieve the target recovery. The target recovery for the NF plant 113 is 50% (or 0-60%) where 50% of the feed that is filtered reports to the NF permeate tank 133. The target recovery should be adjusted in accordance with the plant operating temperature, where 50% recovery can be achieved at 110 deg F. and approximately 30% at ambient conditions.

High pressure water enters NF membrane stage one 191 and progresses through to stage three 195, and a portion of the feed solution permeates through each NF membrane element in a controlled fashion at a desired flux rate which may be anywhere from 0 to 25 gfd (gallons per square ft per day). The desired flux rate is achieved by manipulating the flux control valves as the target permeate flow is measured by individual stage permeate flow meters, or train permeate flow meters if multiple trains are employed. Flux rates may be in the range of 4 to 11 gfd. Typically, stage one flux rate would be set to about 9.8 gfd, stage 2 flux rate would be set to about 6.1 gfd and stage 3 flux rate would be set to about 5.3 gfd The remaining feed is bled from the system via the concentrate pressure control valve at the desired plant recovery. Manual valves allow the plant to be isolated for maintenance, and sample valves allow for the interrogation of system performance. Thirty NF membrane modules are required for the NF plant 113 with each module having an area of 400 sqft (37.2 m2).

Permeate produced by the NF plant has a TDS approximately 50% lower than the feed water, with significant reductions in F (˜75% reduction), Si (˜70% reduction), and sulfate (˜65% reduction). The reduction of these components greatly reduces the propensity for scaling on the permeate side of the membrane, and provides a fluid that can be readily treated by an essentially standard sea water RO plant. NF permeate is stored in the NF permeate tank where level and temperature are monitored. The NF permeate tank level has feedback to the NF plant to adjust plant operating conditions to avoid overfilling the tank.

To manage the different operating conditions across the NF plant a monitoring system and membrane cleaning regime is incorporated into the plant. Some of the features of the scale management system on the NF plant include individual membrane unit monitoring for flow and pressure as well as an ability to take offline portions of the plant (unit) for cleaning, whilst leaving the remaining plant fully operational. Even though both flow and pressure are monitored, the key criteria for scale management is time based cleaning, i.e. performing the cleaning at pre-determined durations rather than allowing for the onset of scale formation which in turn impacts both flow and operating pressure.

The NF plant 113 is maintained via a multifaceted cleaning system which includes the combination of flushing and chemical cleaning, or clean in place (CIP) sequences using multiple proprietary cleaning solutions. These sequences are timed and may also be operator initiated. Both methods of cleaning involve a sequence of valve openings and closures in a predetermined sequence to enable cleaning solutions to enter the plant.

Chemical cleaning of the NF requires the unit to be taken off line and isolated from the main process stream. When assembled in multiple trains the plant is configured such that a portion of the plant can be taken offline for chemical cleaning. A portion of the 3rd stage can be taken off line, portion of the 2nd stage and 3rd stage independently. Whilst off line, a cleaning solution consisting of an acidic solution and an alkaline solution may circulated through the membrane at intervals effectively dissolving and dispersing any accumulated solids and chemical fouling. The cycle duration of the chemical clean is about an hour and it occurs about once every one to four days.

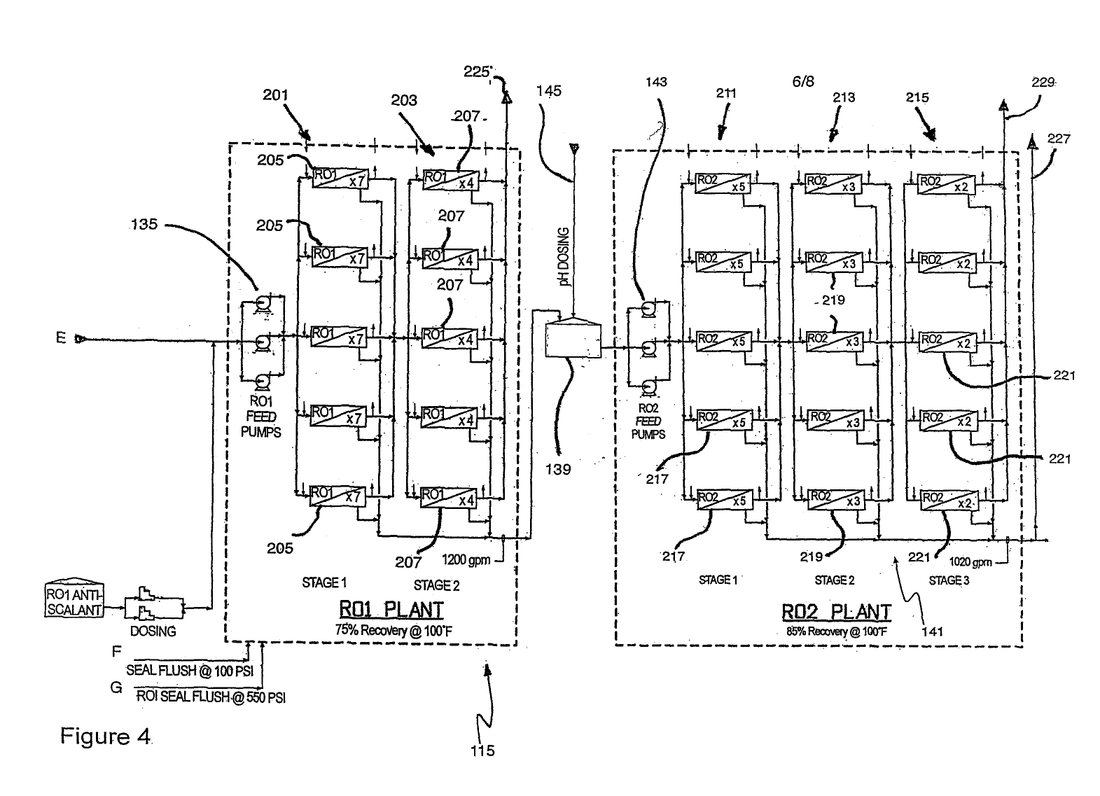

Referring to FIG. 4, detail of the first reverse osmosis plant 115 and the second reverse osmosis plant 141 is shown. The first reverse osmosis plant 115 has two stages 201 and 203, each of five reverse osmosis units 205 and 207 in parallel. The reverse osmosis units 205 each comprise seven reverse osmosis housings each containing six reverse osmosis modules or canisters of the type illustrated in FIG. 1, while the reverse osmosis units 207 each comprise four reverse osmosis housings each containing six reverse osmosis modules or canisters of the type illustrated in FIG. 1.

The second reverse osmosis plant 141 has three stages 211, 213 and 215, each of five reverse osmosis units 217, 219 and 221 in parallel. The reverse osmosis units 217 each comprise five reverse osmosis housings each containing six reverse osmosis modules or canisters of the type illustrated in FIG. 1. The reverse osmosis units 219 each comprise three reverse osmosis housings each containing six reverse osmosis modules or canisters of the type illustrated in FIG. 1, and the reverse osmosis units 221 each comprise two reverse osmosis housings each containing six reverse osmosis modules or canisters of the type illustrated in FIG. 1.

The feed to the first reverse osmosis plant 115 is a complex saline solution but with most of the species with a propensity for scaling reduced in the prior (NF) process. The key characteristics of the stream include (all stated as ppm) TDS of ˜17,000, P ˜4100, sulfate ˜3,000, fluoride ˜2200, sodium ˜550, and silica ˜500. As such this stream is materially different to the untreated liquor and has been shown to be significantly easier to manage and treat than the raw feed liquor. Whilst the silica level is considered high by normal reverse osmosis standards, the silica at this point is in a form which can be readily managed by an appropriate cleaning regime.

The plant operates in a very low pH environment with the feed stream having a pH less than 2.5. The first pass RO removes significant quantities of phosphorous, nitrogen, fluoride, calcium, manganese, iron, silica, sodium and sulfate and in turn reducing the overall feed stream TDS from over 17,000 ppm to approximately 350 ppm in the permeate.

The first reverse osmosis plant 115 operates at a 75% recovery which may be considered reasonably high, but the majority of the scaling materials have been reduced in the prior UF plant 110 and NF plant 113 processes. The high fluoride levels and low pH environment dictates the need to use stainless steel membrane housings in lieu of the traditional fiberglass reinforced plastic housings, but otherwise the plant closely resembles a traditional seawater reverse osmosis water treatment plant.

As the plant has the possibility of scaling, a control and monitoring system similar to that specified for the NF plant 113 is provided. The cleaning regime for the first reverse osmosis plant 115 utilizes a low pH cleaning solution only.

The permeate flowing from the first reverse osmosis plant 115 is delivered to the RO permeate holding tank 139. It is very clean water with the exception that it is of very low pH and not suitable for discharge to local environments but may be suitable for reuse for other purposes. The permeate from the first reverse osmosis plant 115 is essentially free of all analytes of importance with the exception of fluoride and at low pH the permeate exists as an essentially pure but dilute stream of hydrofluoric acid at less than 0.1% HF. The concentrate stream 225 from the from the first reverse osmosis plant 115 is relatively rich in P2O5 which is intended to be recycled directly to phosphate production, but a portion of this concentrate is fed back to the UF permeate holding tank 121 where it is mixed with UF permeate, to be supplied with antiscaling agent to the NF plant.

The feed to the second reverse osmosis plant 141 is low in TDS and therefore the prime purpose of the second reverse osmosis plant 141 is to remove the remaining fluoride from the stream. To facilitate and improve the removal of fluoride through the second reverse osmosis plant 141, the pH of the feed is increased to a minimum of pH of 80 using sodium hydroxide added to the RO1 permeate tank 139, where the fluoride associates with sodium to form a salt which can be rejected by the membrane. The resultant permeate from the second reverse osmosis plant 141 is a very pure water stream 227 of extremely low conductivity dissolved solids.

The second reverse osmosis plant 141 feed water has very little chemical buffering as a result of the prior treatment processes, therefore the quantity of NaOH required to raise the pH to 8-9.5 is minimal. Some post treatment may be required to manage the treated water to preferred discharge pH limits. As with the first reverse osmosis plant 115, the second reverse osmosis plant 141 uses standard seawater RO membranes which are available from a number of suppliers.

The second reverse osmosis plant 141 operates at a nominal recovery of 85%. The second reverse osmosis plant 141 concentrate 229 or retentate is essentially clean water of a neutral pH with very high concentration of fluoride (approx. 1500 ppm). The concentrate from the second reverse osmosis plant contains NaF, which is acidified using H2SO4 and used to clean silica deposits from the UF and NF plants.

### EXAMPLE

The following example further illustrates an embodiment of the present process.

A pilot plant for a multistage membrane process with a sequential series of ultrafiltration (UF), nanofiltration (NF), and two reverse osmosis (RO) stages was constructed to simulate the treatment facility described above in connection with the second embodiment. Over a series of weeks, process water from a phosphate fertilizer plant was fed into the pilot plant with average concentrations according to Table 1 below.

The plant was operated with nominal permeate recovery of 50% for ultrafiltration, 40% for nanofiltration, 75% for RO1 and 85% for R02. The plant was operated with a feed temperature of 110-120° F. The pH was adjusted to at above 8.5 between the first reverse osmosis stage (RO1) and the second reverse osmosis stage (RO2) as described above in connection with the second embodiment.

The resultant permeate streams achieved average concentrations of fluoride, phosphorus and nitrogen according to Table 1 below. Turbidity was reduced from 22-60 NTU in the process water feed to less than 1 NTU in the UF permeate and to below the detection limits downstream of the NF stage.

TABLE 1
Average results over one month operation.

| | | Feed | | | | | | | | |
|---|---|---|---|---|---|---|---|---|---|---|
| | | Water | | UF | | NF | | RO1 | | RO2 |
| Fluid | | Average | UF | Retentate | NF | Retentate | RO1 | Retentate | RO2 | Retentate |
| Components | Units | Conc. | Permeate | (calculated) | Permeate | (calculated) | Permeate | (calculated) | Permeate | (calculated) |
| Permeate | | | 50% | | 40% | | 75% | | 85% | |
| Recovery | | | | | | | | | | |
| Phosphorus | Mg/L | 6020 | 6020 | 6020 | 1530 | 9013 | 16 | 6072 | ND | 107 |
| Fluoride | Mg/L | 6970 | 6970 | 6970 | 1050 | 10917 | 193 | 3621 | 4.2 | 1263 |
| Ammonium | Mg/L | 725 | 725 | 725 | 160 | 1102 | 10 | 610 | ND | 67 |
| Calcium | Mg/L | 920 | 920 | 920 | 27 | 1515 | ND | 108 | ND | 0 |
| Sulfate | Mg/L | 1860 | 1860 | 1860 | 310 | 2893 | 1.3 | 1236 | ND | 9 |
| Silica | Mg/L | 1540 | 1540 | 1540 | 280 | 2380 | 12.5 | 1083 | 2.9 | 83 |
| pH | Std. | <1.5 | <1.5 | <1.5 | <1.8 | NA | >8.5* | NA | <8.5 | NA |
| | Units | | | | | | | | | |
| Turbidity | NTU | 40.8 | 0.5 | 81 | NA | 1 | ND | 0 | ND | 0 |

*pH adjusted

The results of this example demonstrate that the process is capable of delivering water at appropriate concentrations for discharge. The results also demonstrate that there is concentration of phosphate in the NF retentate which can be recycled back to a phosphate production facility; the RO1 retentate is also phosphate bearing and similarly suitable for recycling. Further, the results clearly demonstrate that the RO2 retentate is essentially clean water with a very high concentration of fluoride, which, after acidification, is suitable for cleaning silica deposits in the UF and NF plants.

The present process provides a useful alternative to known techniques which have tended to rely on reactions to precipitate out some ionic values from solution, and then remove them using filtration. This precipitation results in the ionic values being locked up in a form in which it is not economically viable to recover, creating disposal problems. In contrast the present process and plant can be used to retain ionic values in a form where they can be recovered and reused.

It should be appreciated that the scope of the invention is not limited to the particular embodiments disclosed herein. What has been described above has been intended to be illustrative of the invention and non-limiting and it will be understood by persons skilled in the art that other variants and modifications may be made without departing from the scope of the invention as defined in the claims appended hereto.

1. A process for the treatment of an aqueous solution containing substantial concentrations of a variety of contaminants which may include solids, semi-solids, colloids, complexes, oligomers, polyvalents, organics and monovalents, and which tend to form gels and scale precipitates when their concentration levels are increased during treatment of the aqueous solution, said process comprising the steps of:
a) feeding the aqueous solution to an ultrafiltration (UF) plant and recovering therefrom an UF permeate reduced in such suspended solids, semi-solids and colloids;
b) feeding the UF permeate obtained from step (a) to a nanofiltration (NF) plant and recovering therefrom an NF permeate reduced in such complexes, oligomers, polyvalents and organics; and
c) feeding the NF permeate obtained from step (b) to a first reverse osmosis (RO) plant and recovering therefrom an RO permeate reduced in such monovalents.

2. The process of claim 1, wherein the aqueous solution contains at least some species from the group consisting of phosphates, silica compounds, fluorosilicates, sulfates, fluoride, metals, ammonium compounds, and organics.

3. The process of claim 2, wherein at least some of said species are present in the aqueous solution at or near their saturation levels.

4. The process of claim 1, wherein the aqueous solution is process water from wet process phosphoric acid production.

5. The process of claim 1, further comprising the steps of recovering a phosphate bearing retentate from the nanofiltration plant and recycling a portion of such phosphate bearing retentate to phosphate production.

6. The process of claim 1, wherein the RO permeate obtained from step (c) contains fluoride, and further comprising the step of feeding the RO permeate obtained from step (c) to a second reverse osmosis (RO) plant and recovering therefrom a second RO permeate reduced in fluoride.

7. The process of claim 6, wherein an alkaline agent is added to the RO permeate obtained from step (c) raising its pH to at least 8.0 prior to feeding it to the second reverse osmosis (RO) plant.

8. The process of claim 6, further comprising the steps of recovering a retentate from the first reverse osmosis plant and feeding a portion of such retentate to the nanofiltration plant by adding it to the UF permeate obtained from step (a).

9. The process of claim 1, further comprising the steps of recovering a sodium fluoride bearing retentate from the reverse osmosis plant, adding sulfuric acid to at least a portion of such sodium fluoride bearing retentate, and using the resulting solution to clean mineral deposits in the UF and NF plants.

10. The process of claim 6, further comprising the steps of recovering a sodium fluoride bearing retentate from the second reverse osmosis plant, adding sulfuric acid to at least a portion of such sodium fluoride bearing retentate, and using the resulting solution to clean mineral deposits in at least one of the ultrafiltration, nanofiltration, or reverse osmosis plants.

11. The process of claim 1, wherein the UF permeate obtained from step (a) contains fewer than 15% of the suspended solids, semi-solids and colloids present in the aqueous solution.

12. The process of claim 1, wherein the NF permeate obtained from step (b) contains fewer than 30% of the complexes, oligomers, polyvalents and organics present in the aqueous solution.

13. A facility for the treatment of an aqueous solution containing substantial concentrations of a variety of contaminants which may include solids, semi-solids, colloids, complexes, oligomers, polyvalents, organics and monovalents, and which tend to form gels and scale precipitates when their concentration levels are increased during treatment of the aqueous solution, said facility comprising:
a) an ultrafiltration (UF) plant that is operable to receive the aqueous solution and produce an UF permeate reduced in such suspended solids, semi-solids and colloids;
b) a nanofiltration (NF) plant that is downstream of the ultrafiltration plant and that is operable to receive the UF permeate and produce an NF permeate reduced in such complexes, oligomers, polyvalents and organics; and
c) a first reverse osmosis (RO) plant that is downstream of the nanofiltration plant and that is operable to receive the NF permeate and produce an RO permeate reduced in such monovalents.

14. The treatment facility of claim 13, wherein the treatment facility is integral to a wet process phosphoric acid production plant and the aqueous solution is process water from the phosphoric acid production plant.

15. The treatment facility of claim 14, wherein a portion of the retentate from the nanofiltration plant is recycled to the phosphoric acid production plant.

16. The treatment facility of claim 13, further comprising a second reverse osmosis (RO) plant that is downstream of the first reverse osmosis plant and that is operable to receive the RO permeate from the first reverse osmosis plant and produce a second RO permeate reduced in fluoride.

17. The treatment facility of claim 16, further comprising an alkalizing stage for raising the pH of the RO permeate from the first reverse osmosis plant to at least 8.0 prior to its being received by the second reverse osmosis plant.

18. The treatment facility of claim 16, wherein a portion of the retentate from the first reverse osmosis plant is fed to the nanofiltration plant.

19. The treatment facility of claim 13, further comprising an acidifying station for adding sulfuric acid to the retentate from one of the reverse osmosis plants to produce a solution for cleaning mineral deposits in at least one of the ultrafiltration, nanofiltration, or reverse osmosis plants.
